(19) United States
(12) Patent Application Publication
(10) Pub. No.: US 2013/0162038 A1
(43) Pub. Date: Jun. 27, 2013

(54) APPARATUS AND METHOD FOR STABILIZING AN ELECTRICAL POWER IMPORT

(71) Applicants: Rainer Falk, Poing (DE); Steffen Fries, Baldham (DE); Hans-Joachim Hof, Ingolstadt (DE)

(72) Inventors: Rainer Falk, Poing (DE); Steffen Fries, Baldham (DE); Hans-Joachim Hof, Ingolstadt (DE)

(73) Assignee: SIEMENS AKTIENGESELLSCHAFT, Muenchen (DE)

(21) Appl. No.: 13/642,598

(22) PCT Filed: Mar. 8, 2011
(86) PCT No.: PCT/EP2011/053416

§ 371 Date: Nov. 19, 2012

(30) Foreign Application Priority Data
Apr. 22, 2010 (DE) 10 2010 017 935.3

(51) Int. Cl. H02J 4/00

(52) U.S. Cl. CPC H02J 4/00
USPC 307/26

(57) ABSTRACT

An apparatus and a method for stabilizing an electrical power import from a power distribution system by way of at least one subscriber connected to the power distribution system via an electrical connection. An electrical power import anomaly when electrical power is imported by the respective subscriber from the power distribution system is identified using transmitted control messages, which are determined for the respective subscriber or originate from the respective subscriber. Once an electrical power import anomaly has been identified, power consumption units or power generation units are driven correspondingly. The apparatus effectively protects the power distribution system from third-party intervention or implementation errors which can bring about an unstable system response.

The invention relates to an apparatus and a method for stabilizing an electrical power import from an electrical power distribution network.

A multiplicity of different subscribers, each having a plurality of electrical power consumption units, can be connected to an electrical power distribution network. Such subscribers can be households having a multiplicity of different household devices such as washing machines, refrigerators and the like. Such subscribers can also be production plants that use machines which require electrical power in the manufacture of products. Various electrical power generating equipment or electrical power generators can be connected to such a conventional electrical power distribution network, in particular power stations, but also photovoltaic installations and wind power installations. In addition, electrical power is increasingly being fed into the network by decentralized electrical power generating units, e.g. by a photovoltaic installation that is fixed to the roof of a subscriber. Devices and/or machines of subscribers are increasingly being controlled in order to save energy. The control of these subscriber devices can be effected centrally by a control system of the electrical power supplier or locally on the premises of the subscribers, e.g. by means of an intelligent level control that controls or regulates the household devices in a household. For example, the lighting in a building can be adapted to the current ambient brightness by means of a local control unit providing corresponding control or regulation of lighting equipment.

Moreover, occurrences of electrical power consumption that are caused by devices can be controlled correspondingly. For example, a washing machine can be activated by a local control unit, which is provided on the premises of the subscriber, when the electrical power that is available in the electrical power network or the available energy can be imported by the subscriber at favorable conditions. Both the remote control by a remotely situated central control unit of the electrical power supplier and the local control on the premises of the subscriber are based on a networked data transmission system.

Such control systems, which can be implemented on the premises of multiple different subscribers, are increasingly exposed to the danger of unauthorized intervention by third parties. For example, the danger exists that an unauthorized user could succeed in gaining control over a large number of control units of various subscribers and destabilize the electrical power distribution network by means of a targeted unauthorized intervention. For example, an unauthorized user could switch a multiplicity of devices on and off simultaneously, said devices being under local or decentralized control, and thus cause electrical power consumption fluctuations that destabilize the electrical power distribution network. The destabilization of the electrical power network could possibly result in electrical power failures in the electrical power distribution network. However, such an unstable system state of the electrical power distribution network can also be caused, as a consequence of planned unauthorized intervention by a third party, by an unstable unplanned control response of the overall system. This could be due to an implementation error in existing control software or an error in the control algorithm that is used.

The object of the present invention is therefore to create an apparatus and a method which ensure that such an electrical power distribution network remains stable at all times, even in the event of unauthorized interventions by third parties or implementation errors.

This object is achieved according to the invention by an apparatus having the features specified in claim 1.

The invention provides an apparatus for stabilizing an electrical power import from an electrical power distribution network by at least one subscriber which is connected to the electrical power distribution network via an electrical connection interface,

wherein an electrical power import anomaly during the import of electrical power by the respective subscriber from the electrical power distribution network is identified on the basis of transmitted control messages which are destined for the respective subscriber or originate from the respective subscriber, and wherein electrical power consumption units are driven correspondingly after an electrical power import anomaly has been identified.

In an embodiment of the apparatus according to the invention, a plurality of electrical power consumption units of the respective subscriber are connected via a gateway and the electrical connection interface of the subscriber to a distribution station, which is provided for the subscriber, of the electrical power distribution network.

This distribution station is e.g. a transformer station of the electrical power distribution network.

In an embodiment of the apparatus according to the invention, the electrical power import anomaly of a subscriber is identified by an electrical power import anomaly identification unit which is provided in the gateway of the respective subscriber, in the distribution station that is provided for the respective subscriber, or in a server of an electrical power supplier.

In an embodiment of the apparatus according to the invention, after identification of an electrical power import anomaly on the premises of a subscriber, at least some of the electrical power consumption units of the subscriber and/or further subscribers are switched from a normal operating mode to a restricted operating mode or deactivated completely.

In an embodiment of the apparatus according to the invention, an electrical power consumption calculation unit is provided for the respective subscriber, wherein the electrical power that is consumed by the electrical power consumption units of the respective subscriber is calculated continuously or as required and is reported to the electrical power import anomaly identification unit of the respective subscriber by said electrical power consumption calculation unit.

In a possible embodiment of the apparatus according to the invention, the electrical power import anomaly identification unit identifies an electrical power import anomaly on the basis of control messages that are sent from the gateway of the subscriber or received by the gateway of the subscriber.

In an embodiment of the apparatus according to the invention, the control messages are transmitted via the electrical connection interface of the subscriber or via a separate data network.

In an embodiment of the apparatus according to the invention, the electrical power import anomaly identification unit of a subscriber identifies an electrical power import anomaly by comparing the transmitted control messages with predefined unauthorized-intervention patterns or with historically recorded data.

In an embodiment of the apparatus according to the invention, the electrical power import anomaly identification unit of a subscriber identifies an electrical power import anomaly whenever the transmitted control messages satisfy at least one configurable identification rule for identifying an electrical power import anomaly.

In an embodiment of the apparatus according to the invention, the electrical power import anomaly identification unit performs one or more additional checks for the purpose of identifying an electrical power import anomaly, in particular

a check of the quantity of electrical power that the subscriber has imported from the electrical power distribution network or fed into the electrical power distribution network via the electrical connection interface,

a check of the integrity of the gateway of the subscriber,

a check of switching instructions that are generated by the gateway of the subscriber, in respect of their chronological sequence and in respect of their frequency.

In an embodiment of the apparatus according to the invention, the control messages of the gateway are transmitted by means of a predefined data transmission protocol and have a predefined data format.

In a possible embodiment of the apparatus according to the invention, the control messages feature data packets comprising administrative data and payload data,

wherein the electrical power import anomaly identification unit identifies an electrical power import anomaly on the basis of conspicuous administrative data and/or conspicuous payload data of the transmitted control messages.

In an embodiment of the apparatus according to the invention, the electrical power import anomaly identification unit identifies an unauthorized intervention that is intended to destabilize the electrical power distribution network on the basis of the control messages, and reports a type and a location of the respective unauthorized intervention to a server of an infrastructure operator of the respective electrical power distribution network.

In an embodiment of the apparatus according to the invention, a local electrical power import anomaly identification unit that is provided in the gateway of a subscriber loads predefined unauthorized-intervention patterns for identifying electrical power import anomalies from a database or receives predefined unauthorized-intervention patterns for identifying electrical power import anomalies in a training mode.

The invention additionally provides a method having the features specified in claim 15 for stabilizing an electrical power import from an electrical power distribution network.

The invention provides a method for stabilizing an electrical power import from an electrical power distribution network,

wherein an electrical power import anomaly during the import of electrical power by at least one subscriber from the electrical power distribution network is identified by analyzing transmitted control messages that are destined for the respective subscriber or originate from the respective subscriber, and

wherein after an electrical power import anomaly on the premises of a subscriber has been identified, electrical power consumption units of the subscriber and/or further subscribers are driven for the purpose of stabilizing the electrical power import.

The invention additionally provides a control program for executing such a method for stabilizing an electrical power import from an electrical power distribution network.

The invention additionally provides a data medium that stores such a control program.

Preferred embodiments of the inventive apparatus and the inventive method for stabilizing an electrical power import from an electrical power distribution network are described below with reference to the appended figures, in which:

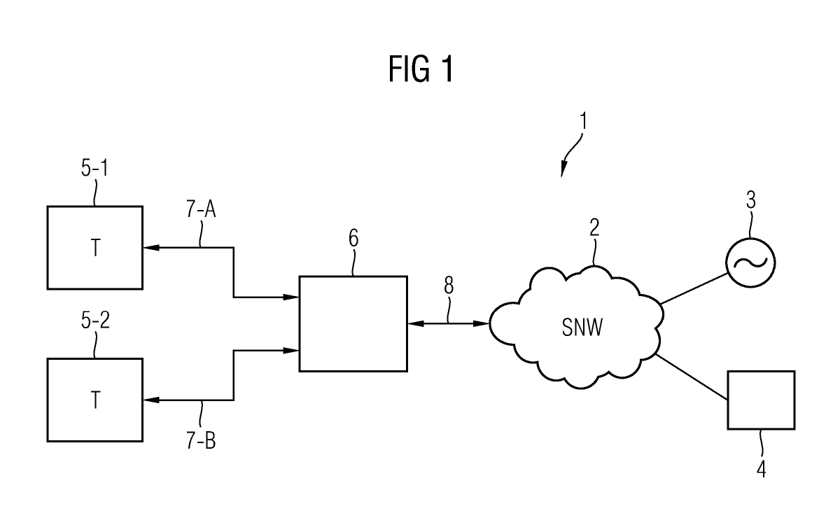

FIG. 1 shows a diagram explaining a system in which use is made of the inventive stabilizing apparatus for stabilizing an electrical power import from an electrical power distribution network;

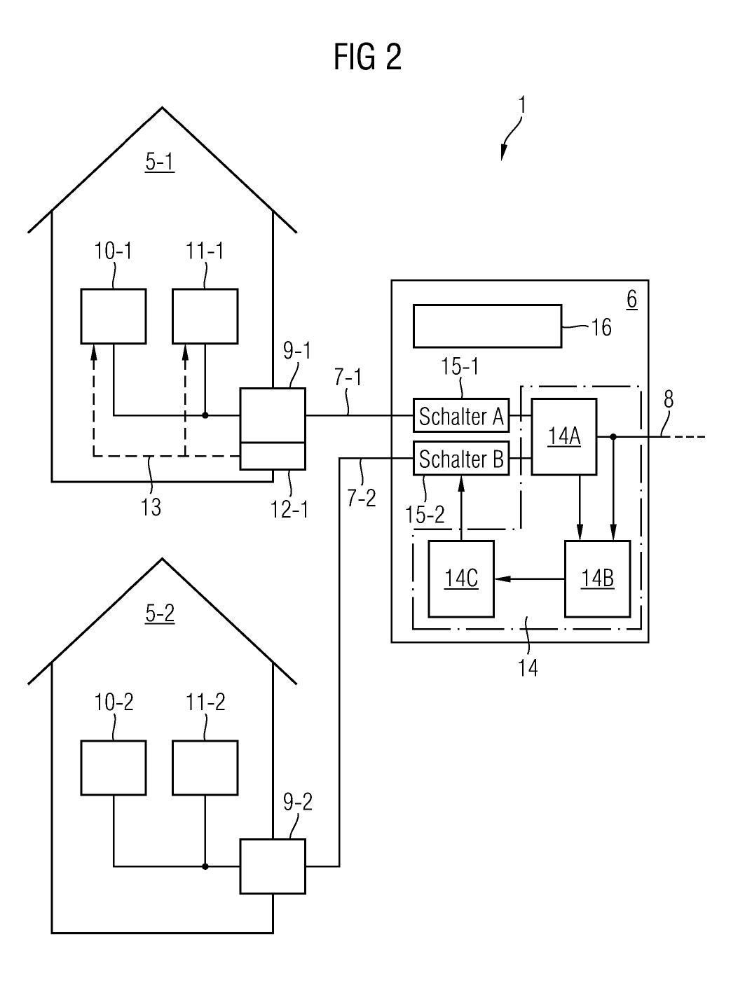

FIG. 2 shows a block diagram illustrating a possible exemplary embodiment of the inventive system for stabilizing an electrical power import;

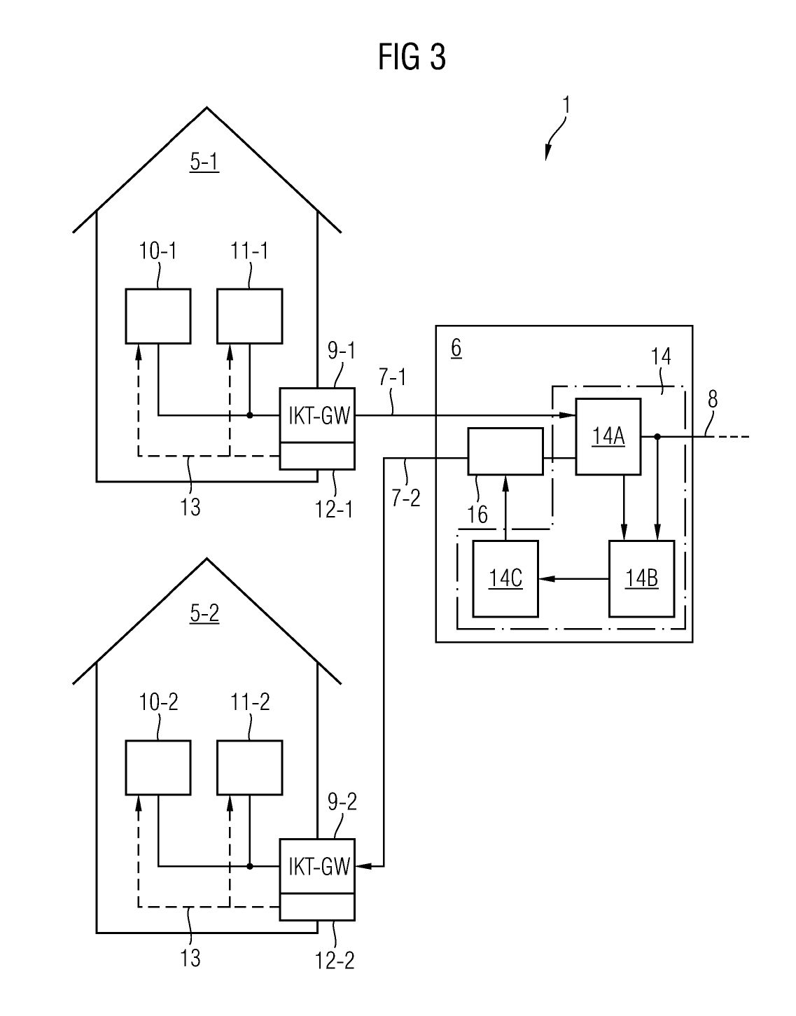

FIG. 3 shows a block diagram illustrating a possible exemplary embodiment of the inventive system for stabilizing an electrical power import;

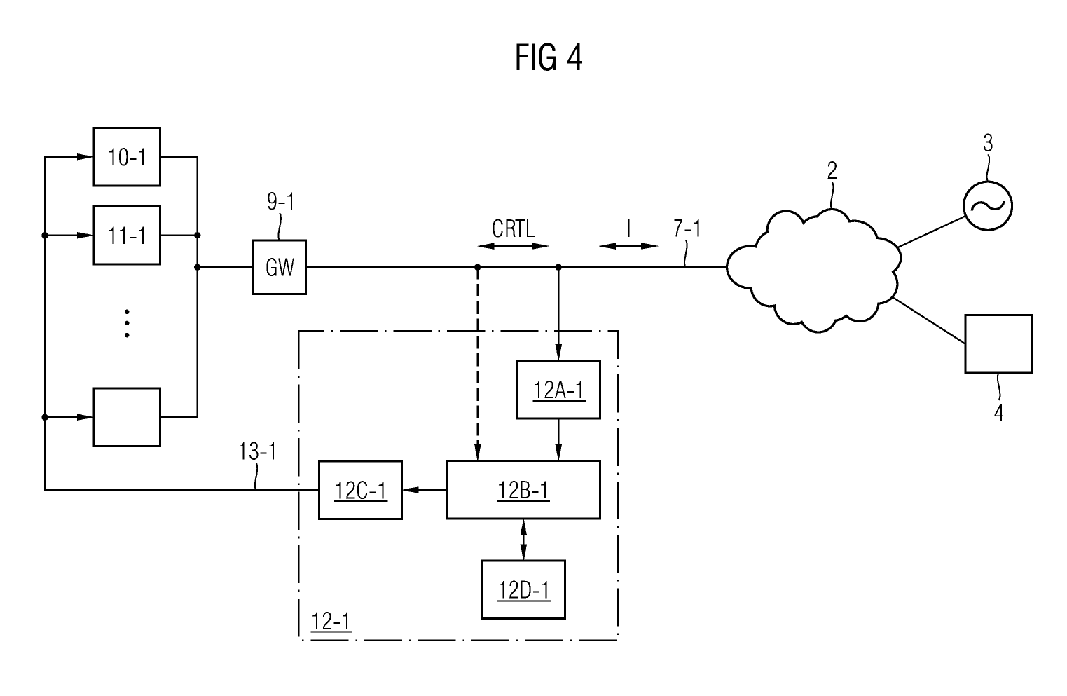

FIG. 4 shows a block diagram illustrating an exemplary embodiment of an inventive apparatus for stabilizing an electrical power import from an electrical power distribution network;

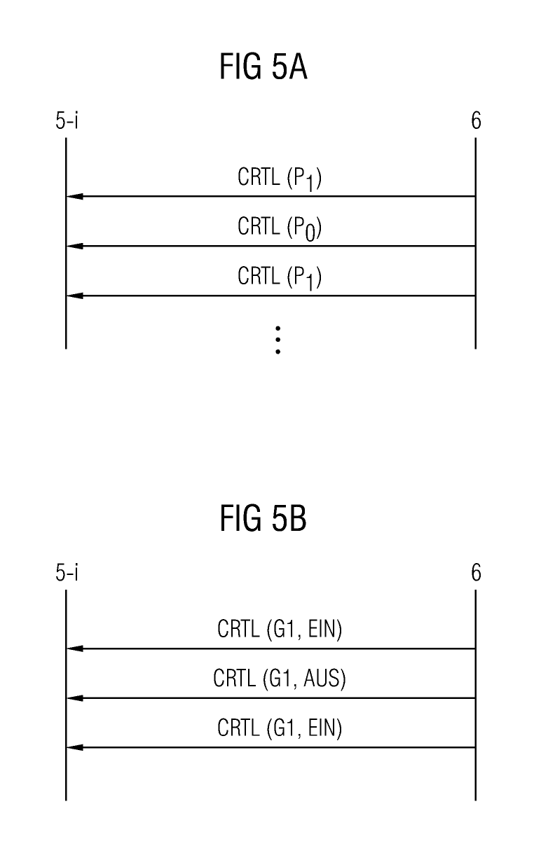

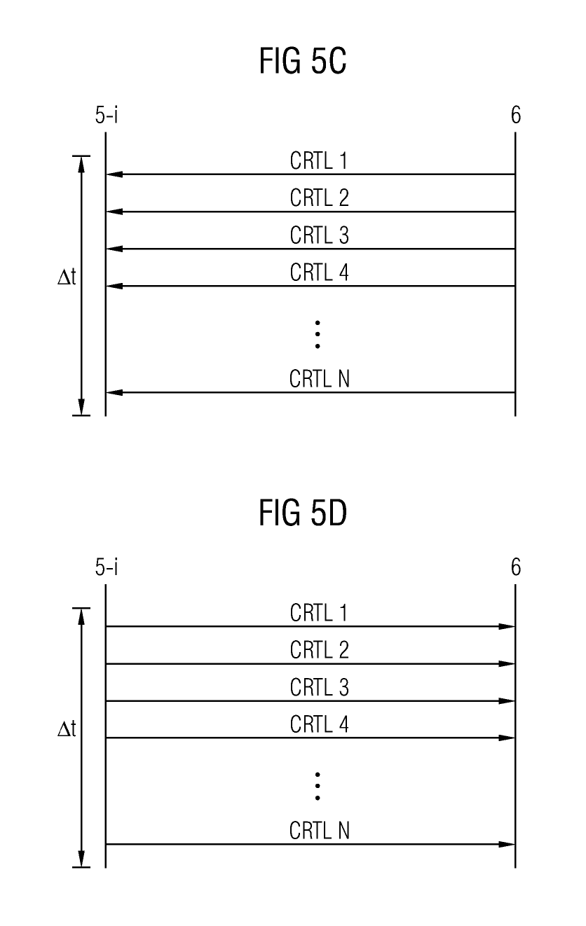

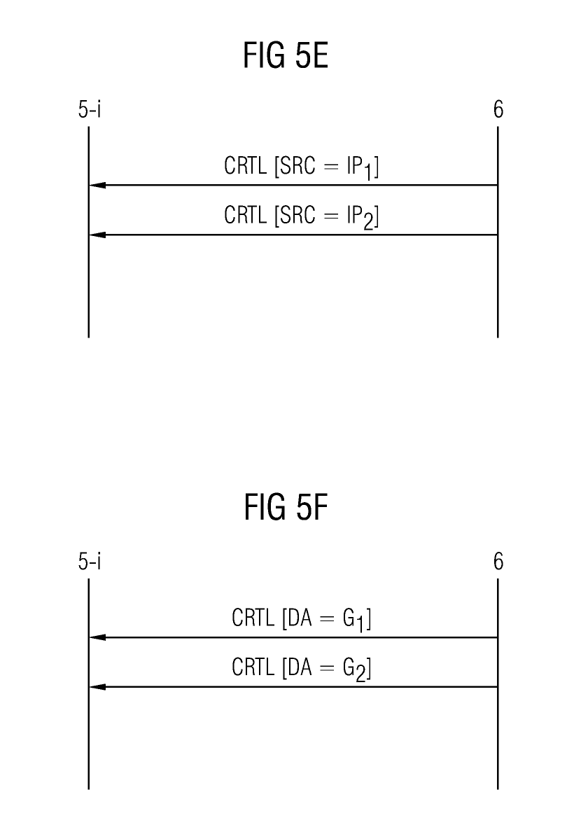

FIGS. 5A-5F show signal diagrams explaining the operation of the inventive apparatus and the inventive method for stabilizing an electrical power import from an electrical power distribution network.

As shown in FIG. 1, a system 1 in which the inventive apparatus can be used for stabilizing an electrical power import features at least one electrical power distribution network 2, into which electrical power is fed by one or more electrical power generators 3 of an electrical power supplier. The electrical power generator 3 is a power station, a wind power installation or a photovoltaic installation, for example. A server 4 of the respective electrical power supplier or infrastructure operator can also be connected to the electrical power distribution network 2. In the exemplary embodiment illustrated in FIG. 1, two subscribers 5-1, 5-2 are connected to the electrical power distribution network 2 via a distribution station 6. The electrical power distribution station 6 can be a transformer station, for example. The two subscribers 5-1, 5-2 are e.g. private households comprising a plurality of electrical power consumption units or production plants comprising machines that consume electrical power for the manufacture of products.

In a possible embodiment, the electrical power distribution network 2 provides an alternating current or AC voltage for the various subscribers 5-1, 5-2. In an alternative embodiment, the electrical power distribution network 2 can provide a direct current or DC voltage for the various subscribers 5-1, 5-2.

The subscribers 5-1, 5-2 are connected to the electrical power distribution station 6 via a subscriber connection interface and an associated electrical connection interface line 7-1, 7-2. The electrical power distribution station 6 in turn is connected to the electrical power distribution network 2 via a line 8. Provision can be made in the electrical power distribution station 6 for a voltage transformer that transforms a high-voltage AC voltage down to a low-voltage AC voltage of lower voltage amplitude, said low-voltage AC voltage being then supplied to the consumer units of the subscriber 5-1, 5-2.

An apparatus for stabilizing an electrical power import from the electrical power distribution network 2 can be provided in each or in one of the two subscribers 5-1, 5-2. In this case, an electrical power import anomaly during the import of electrical power by the respective subscriber 5-i from the electrical power distribution network 2 is identified on the basis of transmitted control messages which are destined for the respective subscriber 5-i or originate from the respective subscriber 5-i. After an electrical power import anomaly on the premises of a subscriber 5-i has been identified, electrical power consumption units or electrical power generation units of the respective subscriber are driven locally for the purpose of stabilizing the electrical power import correspondingly. Alternatively, electrical power consumption units or electrical power generation units of other subscribers, in particular adjacent subscribers that are connected to the same electrical power distribution station 6, can also be driven locally for the purpose of stabilizing the electrical power import. The control messages can be e.g. switching instructions or information relating to the electrical power import (available power, price information, current power consumption), said instructions or information being used for a switching function.

After identifying an electrical power import anomaly on the premises of a subscriber 5-i, at least some of the electrical power consumption units of the subscriber or further subscribers are switched from a normal operating mode to a restricted operating mode or deactivated completely. In a possible embodiment, a plurality of locally provided electrical power consumption units (e.g. household devices) of the respective subscriber 5-i are connected via a gateway and the electrical connection interface of the subscriber 5-i, and via the associated electrical connection interface line 7-i, to the distribution station 6 (of the electrical power distribution network 2) that is provided for the subscriber 5-i. In a possible embodiment, an electrical power import anomaly on the premises of a subscriber 5-i is identified by an electrical power import anomaly identification unit that is provided in the gateway of the respective subscriber 5-i. In an alternative embodiment, an electrical power import anomaly of a subscriber is identified by an electrical power import anomaly identification unit that is provided in the respective distribution station 6 of the subscriber 5-i. Furthermore, the electrical power import anomaly identification unit of the subscriber 5-i can be situated in the server 4 of the electrical power supplier.

In a possible embodiment, an electrical power consumption calculation unit is provided for each subscriber 5-i. This electrical power consumption calculation unit is situated at the gateway of the respective subscriber 5-i, for example. In a possible embodiment, the electrical power consumption calculation unit of the respective subscriber 5-i continuously calculates the electrical power that is consumed by the electrical power consumption units of the respective subscriber 5-i and reports the calculated or measured electrical power consumption to the associated electrical power import anomaly identification unit of the respective subscriber 5-i. In an alternative embodiment, the electrical power consumption calculation unit calculates the electrical power consumption of a subscriber 5-i as required and/or upon receipt of a corresponding input instruction via a user interface, for example. As soon as the electrical power consumption calculation unit receives the corresponding instruction to calculate the consumed electrical power, it reports the consumed electrical power of the subscriber 5-i to the associated electrical power import anomaly identification unit of the respective subscriber 5-i.

The electrical power import anomaly identification unit of a subscriber 5-i identifies the electrical power import anomaly of a subscriber on the basis of control messages that are sent from the gateway of the subscriber 5-i or received by the gateway of the subscriber 5-i. In a possible embodiment, these control messages are transmitted via the electrical connection interface of the subscriber 5-i and the electrical connection interface line 7-i of the respective subscriber 5-i.

In an alternative embodiment, the control messages that are sent from the gateway of the subscriber 5-i or received by the gateway of the subscriber 5-i are transmitted via a separate data network such as the Internet, for example.

In a possible embodiment, the electrical power import anomaly identification unit of a subscriber 5-i identifies an electrical power import anomaly by comparing the transmitted control messages with predefined unauthorized-intervention patterns or with historically recorded data. These unauthorized-intervention patterns and recorded data can be situated in a data store that is locally connected to the electrical power import anomaly identification unit. The data store can be a hard disk, for example. One or more configurable identification rules for identifying an electrical power import anomaly can also be stored in the data store of the subscriber 5-i. In a possible embodiment, the electrical power import anomaly identification unit of a subscriber 5-i identifies an electrical power import anomaly on the premises of the subscriber whenever the control messages sent from the gateway of the subscriber or destined for the gateway of the subscriber satisfy at least one of the stored configurable identification rules for identifying an electrical power import anomaly. In a possible embodiment, the electrical power import anomaly identification unit of a subscriber 5-i identifies an electrical power import anomaly on the premises of the subscriber whenever the control messages and the electrical power consumption that is measured by the electrical power consumption calculation unit are not consistent with each other, e.g. whenever a switch-on instruction or a switch-off instruction does not cause a corresponding change in the measured electrical power consumption.

The control messages of a gateway of a subscriber 5-i are transmitted by means of a predefined data transmission protocol and have a predefined data format. These control messages can be e.g. data packets comprising administrative data (header) and payload data (payload). In a possible embodiment, the electrical power import anomaly identification unit of a subscriber 5-i identifies an electrical power import anomaly on the basis of conspicuous administrative data of the transmitted control message data packets. In an alternative embodiment, the electrical power import anomaly identification unit identifies an electrical power import anomaly on the basis of conspicuous payload data of the transmitted data packets or control messages.

In a possible embodiment, an electrical power import anomaly identification unit of a subscriber 5-i identifies an unauthorized intervention that is intended to destabilize the electrical power distribution network 2 on the basis of the control messages that originate from the gateway of the subscriber 5-i or are received by the gateway of the subscriber 5-i, and reports a type and/or a location of the respective unauthorized intervention to the server 4 of the infrastructure operator of the electrical power distribution network 2. For example, after identification of an unauthorized intervention that is intended to destabilize the electrical power distribution network, the electrical power import anomaly identification unit reports the address of the gateway of the respective subscriber 5-i to the server 4 of the infrastructure operator.

In a possible embodiment, the electrical power import anomaly identification unit is provided locally in the gateway of the subscriber. In a possible embodiment, the identification of an electrical power import anomaly is effected in this case by means of comparison with known unauthorized-intervention patterns, provision being made in a possible embodiment for said unauthorized-intervention patterns to be downloaded from a database by the electrical power import anomaly identification unit of the subscriber 5-i. This database can be provided by the infrastructure operator of the electrical power distribution network 2, for example.

In a possible embodiment, the electrical power import anomaly identification unit of a subscriber 5-i downloads these unauthorized-intervention patterns for identifying electrical power import anomalies from the server 4 of the infrastructure operator. In an alternative embodiment, the electrical power import anomaly identification unit receives such unauthorized-intervention patterns for identifying electrical power import anomalies in a training mode.

FIG. 2 shows an exemplary embodiment of the inventive system 1 for stabilizing an electrical power import from an electrical power distribution network. In the exemplary embodiment illustrated here, both subscribers 5-1, 5-2 (which can be e.g. households of private customers) have a subscriber gateway 9-1, 9-2 via which respective electrical power consumption units 10, 11 are supplied with electrical power. According to the simple example illustrated here, each private household 5-1, 5-2 has two electrical power consumption units 10-1, 11-1 and 10-2, 11-2 respectively. The electrical power consumption units 10, 11 are e.g. household devices such as washing machines or lighting equipment.

As illustrated in FIG. 2, the two gateways 9-1, 9-2 of the two subscribers 5-1, 5-2 are connected via electrical power import lines 7-1, 7-2 to the electrical power distribution station 6, e.g. a transformer station, which in turn is connected via a line 8 to the electrical power distribution network 2. In the exemplary embodiment illustrated in FIG. 2, an inventive apparatus 12-1 for stabilizing an electrical power import from the electrical power distribution network 2 by the subscriber 5-1 is provided at the gateway 9-1 of the first subscriber 5-1. In this case, the apparatus 12-1 can identify an electrical power import anomaly during the import of electrical power by the subscriber 5-1 from the electrical power distribution network 2 via the electrical power distribution station 6 on the basis of transmitted control messages that originate from the associated gateway 9-1 of the subscriber 5-1 or are received by or destined for the gateway 9-1 of the subscriber 5-1. In response to the identification of an electrical power import anomaly, electrical power consumption units or electrical power import units can be driven correspondingly by the apparatus 12-1 in order to stabilize the import of electrical power by the subscriber 5-i. In this case, the consumer units of the respective subscriber, specifically the subscriber 5-1 in the example illustrated here, are preferably driven locally by the apparatus 5-1 in order to stabilize the electrical power import. For example, the electrical power consumption units 10-1, 11-1 of the subscriber 5-1 can be driven locally via control lines 13 by the associated apparatus 12-1 for this purpose. In a possible embodiment, after identification of an electrical power import anomaly by the subscriber 5-1 by means of the apparatus 12-1, at least some of the electrical power consumption units 10-1, 11-1 of the respective subscriber 5-1 are deactivated completely and/or disconnected. In a possible embodiment, the disconnection of electrical power consumption units 10, 11 (e.g. household devices) is effected in accordance with a configurable configuration list, wherein electrical power consumption units that are less important to the subscriber are disconnected first. In a possible embodiment as illustrated in FIG. 2, the apparatus 12 for stabilizing an electrical power import from the electrical power distribution network can be provided at the respective gateway 9-i of the respective subscriber 5-i. In the exemplary embodiment illustrated in FIG. 2, only the subscriber 5-i has such a stabilization apparatus 12-i. Alternatively, a plurality of subscribers or all subscribers 5-i can have such a stabilization apparatus 12.

In the exemplary embodiment illustrated in FIG. 2, an apparatus for stabilizing an electrical power import 12-1 is provided on the premises of the subscriber 5-1. Additionally or alternatively, such a stabilization apparatus can also be provided in the electrical power distribution station 6 of the network. In the embodiment illustrated in FIG. 2, an additional apparatus 14 for stabilizing an electrical power import from the electrical power distribution network 2 is situated in the electrical power distribution station 6, wherein this apparatus 14 stabilizes the electrical power import by the subscribers 5-1, 5-2. In the exemplary embodiment illustrated in FIG. 2, the stabilization apparatus that is provided in the distribution station 6 contains an electrical power consumption calculation unit 14A, by means of which the electrical power that is consumed by the electrical power consumption units of the subscribers 5-1, 5-2 is calculated continuously or as required and reported to an electrical power import anomaly identification unit 14B. In a possible embodiment, the electrical power import anomaly identification unit 14B of the stabilization apparatus 14 within the distribution station 6 identifies an electrical power import anomaly, which has been caused by one or both subscribers 5-1, 5-2, on the basis of control messages that are transmitted between the distribution station 6 and the electrical power distribution network 2 via the line 8. In addition, the electrical power import anomaly identification unit 14B in the electrical power distribution station 6 can use the reported total electrical power consumption quantity of the two subscribers 5-1, 5-2, as reported by the electrical power consumption calculation unit 14A, for the purpose of identifying an electrical power import anomaly. In the event of an electrical power import anomaly or an unauthorized intervention, the electrical power import anomaly identification unit 14B in the exemplary embodiment illustrated in FIG. 2 can drive a switching unit 14C that switches the corresponding switches 15-1, 15-2 via which the electrical power supply lines 7-1, 7-2 are connected to the distribution station 6. For example, if the electrical power import anomaly identification unit 14B of the distribution station 6 identifies an unauthorized intervention or an electrical power import anomaly, in a possible embodiment it can activate one or both switches 15-1, 15-2 in order to stabilize the electrical power distribution network 2.

If the gateway 9-2 of the subscriber 5-2 has been infiltrated by an unauthorized user, for example, the unauthorized user has the possibility of periodically activating and deactivating electrical power consumption units and/or loads in the household of the subscriber 5-2. The electrical power consumption calculation unit 14A that is provided in the electrical power distribution station 6 regularly calculates the electrical power consumption of the two subscribers 5-1, 5-2, for example, and communicates the measured electrical power consumption to the electrical power import anomaly identification unit 14B. On the basis of the transmitted control messages and e.g. with reference to a signature database in which unauthorized-intervention patterns are stored, the electrical power import anomaly identification unit 14B can identify that an unauthorized intervention or an implementation error and/or a virus attack has occurred on the premises of the subscriber 5-2. In this case, the electrical power import anomaly identification unit 14B correspondingly drives the switching unit 14C, which then opens the switch 15-2 for the subscriber 5-2 in order thus to minimize the effects of the unauthorized intervention or of the implementation error on the overall network. In the embodiment illustrated in FIG. 2, the distribution station 6 also features a communication unit 16, via which the distribution station 6 communicates with the gateways 9-1, 9-2 of the attached subscribers 5-1, 5-2. In this case, the communication can take place via a separate data network or by means of Powerline Communication PLC.

FIG. 3 shows a further exemplary embodiment explaining the inventive apparatus for stabilizing an electrical power import in an electrical power distribution network. In the exemplary embodiment illustrated in FIG. 3, both subscribers 5-1, 5-2 have a corresponding apparatus 12-1, 12-2 for stabilizing an electrical power import from the electrical power distribution network 2. As in the case of the exemplary embodiment illustrated in FIG. 2, an apparatus 14 for stabilizing an electrical power import is likewise provided in the electrical power distribution station 6. In the exemplary embodiment illustrated in FIG. 3, if an electrical power import anomaly on the premises of the subscriber 5-1 is identified e.g. by an electrical power import anomaly identification unit of the apparatus 12-1 at the gateway 9-1 of the subscriber 5-1, the identified electrical power import anomaly of the subscriber 5-1 can be transmitted via the electrical connection interface line 7-1 of the subscriber 5-1 or via a separate data network to an analysis module of the electrical power distribution station 6, e.g. the electrical power import anomaly identification equipment 14B. The latter can inform an electrical power import anomaly identification unit within the apparatus 12-2 for stabilizing an electrical power import at the gateway 9-2 of the other subscriber 5-2 of a potential electrical power import anomaly, e.g. by means of the communication unit 16 of the distribution station 6. A pattern update of the anomaly data or unauthorized-intervention patterns that are stored there locally can also be performed there if applicable. As a result of the electrical power import anomaly that is identified on the premises of the subscriber 5-1, electrical power consumption units 10-2, 11-2 can therefore be deactivated locally or switched to a restricted operating mode by the apparatus 12-2 on the premises of the other subscriber 5-2. The electrical power import anomaly that is identified on the premises of a subscriber 5-i can therefore result in electrical power consumption units of other subscribers 5-i connected to the same distribution station 6 being also deactivated or restricted, in addition to the electrical power consumption units of the respective subscriber 5-i, in order to stabilize the electrical power network 2. The various devices or electrical power consumption units 10, 11 can be driven differently locally according to their configured priority and/or on the basis of their type. For example, devices that are not safety-critical or electrical power consumption units for lighting a house front or an air conditioning installation can be deactivated completely, while safety-critical electrical power consumption units such as e.g. domestic lighting are not deactivated or are switched to a restricted operating mode, e.g. emergency lighting. In a restricted operating mode, a refrigerator can also adjust itself to a predefined temperature at which it consumes less electrical power, for example.

FIG. 4 shows a further exemplary embodiment of the inventive apparatus 12 for stabilizing an electrical power import. In the exemplary embodiment illustrated in FIG. 4, the stabilization apparatus 12-1 is situated at the home gateway 9-1 of a subscriber 5-1, which is connected directly to the electrical power distribution network 2 via an electrical power supply line 7-1. Therefore no electrical power distribution station 6 is provided in the exemplary embodiment illustrated in FIG. 4. The electrical power stabilization apparatus 12-1 that is provided at the gateway 9-1 of the subscriber 5-1 contains an integrated electrical power consumption calculation unit 12A-1, by means of which the electrical power that is consumed by the electrical power consumption units 10-1, 11-1 of the subscriber 5-1 is calculated continuously or as required and reported to an electrical power consumption anomaly identification unit 12B-1 of the subscriber 5-1. This controls the electrical power consumption units 10-1, 11-1 of the subscriber 5-1 via a switching unit 12C-1. In the exemplary embodiment illustrated in FIG. 4, the local electrical power consumption anomaly identification unit 12B-1 is also connected to a data store 12D-1. The electrical power import anomaly identification unit 12A-1 identifies an electrical power import anomaly during the import of electrical power by the subscriber 5-1 from the electrical power distribution network 2 on the basis of transmitted control messages, these being destined for the subscriber 5-1 or originating from the respective subscriber 5-2. In response to the identification by an electrical power consumption anomaly identification unit 12B-1, the electrical power consumption units 10-1, 11-1 of the subscriber 5-1 can be driven accordingly by means of the switching unit 12C-1, e.g. by driving sockets of the respective electrical power consumption units 10-1, 11-1 accordingly.

In a possible embodiment, the electrical power import anomaly identification unit 12A-1 performs one or more further checks for the purpose of identifying an electrical power import anomaly on the premises of the respective subscriber. In a possible embodiment, the electrical power consumption anomaly identification unit 12B-1 checks the quantity of electrical power that is imported from the electrical power distribution network 2 or fed into the electrical power distribution network 2 by the subscriber 5-1 via the electrical connection interface 7-1. For example, a plausibility check can be performed in respect of the quantity of electrical power that has been fed in or delivered, e.g. in response to the identification of a cyclical connection or disconnection of electrical power consumption units 10, 11.

In a further possible embodiment, the electrical power import anomaly identification unit 12B-1 additionally checks the integrity of the respective gateway 9-1 of the subscriber 5-1. This integrity check can be performed using Trusted Platform Modules (TPM) or external smartcards, for example, possibly also containing user data.

In a further possible embodiment, the electrical power consumption anomaly identification unit 12B-1 can perform a check of switching instructions that are generated by the gateway 9-1 of the subscriber in respect of their chronological sequence and frequency. For example, a plausibility check of the switching instructions leaving the switching unit 12C-1 is performed in respect of their chronological sequence and their frequency of occurrence. Synchronization with device-specific profiles or policies that may be stored on the respective gateway 9-1 of the subscriber is also possible.

In a possible embodiment, the electrical power consumption anomaly identification unit 12B-1 of the subscriber 5-1, which is provided at the gateway 9-1 of the subscriber 5-1, identifies the electrical power import anomaly on the basis of unauthorized-intervention patterns that are stored locally in the store 12D-1. In a possible embodiment, these unauthorized-intervention patterns for identifying electrical power import anomalies can be loaded from a database of the server 4 or configured in another operating mode.

In a further embodiment, the electrical power consumption anomaly identification unit 12B-1 additionally performs a check of system files in respect of suspicious occurrences, such as e.g. unauthorized data modifications or replacements.

If the electrical power consumption anomaly identification unit 12B-1 discovers an unstable system state or an unauthorized intervention, in a possible embodiment the electrical power import anomaly identification unit 12B-1 can switch itself to a secure operating mode, in which the possibilities of influencing electrical power consumption units of the subscriber are restricted or prevented. In a further possible embodiment, in response to the identification of an unstable system state and/or an unauthorized intervention, the electrical power import anomaly identification unit 12B-1 can send messages to locally connected intelligent electrical power consumption units 10-1, 11-1 of the subscriber 5-1, reporting the unauthorized intervention and/or the unstable system state to these intelligent electrical power consumption units 10-1, 11-1. The stabilization apparatus 12-1 for stabilizing the electrical power import performs a watchdog function in respect of the energy consumption and a protection function in respect of unauthorized intervention. In a possible embodiment, the electrical power consumption units that are deactivated by the apparatus 12-1 in order to stabilize the electrical power consumption can be reactivated manually or automatically by the apparatus 12-1, e.g. by means of manual interaction by the subscriber or user after a predefined time period has elapsed. In a possible embodiment, unauthorized-intervention notifications are also sent periodically and in an integrity-protected manner to a communication unit of an electrical power distribution station 6 or to locally connected electrical power consumption units 10-1, 11-1.

The electrical power consumption calculation unit 12A-1 can calculate the electrical power consumption of the respective subscriber 5-1 continuously or as required. In a possible embodiment, the calculated electrical power consumption can be reported to a communication unit 16 of the electrical power distribution station 6.

In a possible embodiment, the configuration of the stabilization apparatus 12-1 can be performed remotely using unauthorized-intervention patterns for the purpose of identifying electrical power import anomalies. Alternatively, individual synchronization with a specific household or the premises of a specific subscriber can take place locally in a training mode for the electrical power consumption anomaly identification unit 12B-1 of the apparatus 12-1.

The FIGS. 5A, 5B, 5C, 5D, 5E, 5F show examples explaining the inventive method and the inventive apparatus for stabilizing an electrical power import from an electrical power distribution network. The FIGS. 5A-5F show examples of communication between a subscriber 5-i and an electrical power distribution station 6, e.g. via the electrical connection interface lines 7-i or a separate data network.

The example illustrated in FIG. 5A shows control messages of the distribution station 6 that are transmitted to a subscriber 5-i within a specific time period. In the example illustrated here, the control messages are messages that inform the subscriber 5-i of a current price P of electrical power from an electrical power supplier. In the example illustrated here, the subscriber 5-i is notified of electrical power prices that change continuously within a short time period, fluctuating between a price P1 and a price P0, and this could therefore result in devices being switched on or off continuously on the premises of the subscriber 5-i. Following the occurrence of such an unauthorized-intervention pattern, the stabilization apparatus 12-i that is provided on the premises of the subscriber 5-i can identify a corresponding unauthorized intervention and drive the electrical power consumption units accordingly, e.g. deactivate them. A corresponding error report can also be transmitted to a server 4 of the electrical power operator.

According to the unauthorized-intervention example illustrated in FIG. 5B, a household device that is turned off at the premises of the subscriber 5-i, specifically the household device G1 as electrical power consumption unit 10, 11, is continuously switched on or off. If such an unauthorized-intervention pattern is identified, the corresponding household device G1 or the corresponding electrical power consumption unit can be switched to a restricted operating mode or deactivated completely, for example. A further possibility consists in instructing the affected device to ignore the corresponding control instruction.

FIG. 5C shows a further example of a possible unauthorized intervention. The unauthorized intervention illustrated in FIG. 5C is a so-called Denial-of-Service unauthorized intervention, as a result of which the distribution station 6 sends a large number of control instructions or control messages to a gateway 9-1 of a subscriber 5-i within a specific time period, in order to congest the corresponding gateway 9-1. For example, several thousand control messages are generated by the unauthorized intervention and sent to the gateway 9-1 of the subscriber 5-i within a few milliseconds.

FIG. 5D shows a further example of an unauthorized-intervention pattern on the basis of which a possible unauthorized intervention can be identified. In the example illustrated in FIG. 5D, a subscriber 5-i sends a multiplicity of control messages to a distribution station 6 or to a server within a relatively short time period Δt, in order to achieve corresponding congestion or overloading.

FIG. 5E shows a further example of the identification of a possible unauthorized-intervention pattern. In the example illustrated in FIG. 5E, the distribution station 6 sends two control instructions (e.g. switch-on instructions) to a destination address of a device on the premises of the subscriber 5-i, wherein said control instructions have different source addresses SRC (e.g. IP addresses). For example, the IP address IP1 can be a valid source address while the other source address IP2 lies in an incorrect invalid address range. If such an unauthorized intervention is identified, the second control message CRTL having the source address IP2 can be ignored or blocked by the respective subscriber 5-i, for example. In the exemplary embodiment illustrated here, the inventive apparatus 12 therefore provides firewall functionality in respect of a control instruction or control message.

In the example illustrated in FIG. 5F, the subscriber 5-i receives control messages having different receive addresses DA (destruction address) for different devices G1, G2 of the subscriber 5-i from the electrical power distribution station 6. For example, the control instruction for the second electrical power consumption unit G2 might relate to an electrical power consumption unit of the subscriber 5-i that is safety-critical and is therefore not allowed to be driven externally. In this case, the inventive apparatus 12 can block the corresponding control instruction for the safety-critical device G2. It is also possible to generate a corresponding report, reporting the unauthorized intervention that has possibly been identified.

The monitoring of the control message or of the network traffic can be effected by means of comparison with known unauthorized-access signatures for checking on the basis of historical data.

The inventive method reduces the vulnerability of the electrical power network 2 in respect of malfunction and/or unauthorized access. Reliable operation of the Smartgrid or the electrical power network 2 is ensured in this case, even if unstable operation occurs as a result of unauthorized access or an unforeseen system state. The inventive stabilization method also reduces collateral damage that can be caused by network disconnections. In particular, any effects of a local electrical power import problem are restricted to the local area. In the event of an unauthorized intervention or a system state as specified above, preferably only those subscribers which are potentially infected are separated from the electrical power network 2 or switched to an emergency operating mode. Using the inventive method for stabilizing an electrical power import, an electrical power import anomaly during the import of electrical power by at least one subscriber from the electrical power distribution network 2 is identified by analyzing transmitted control messages that are destined for the respective subscriber 5-i or originate from the respective subscriber. After an electrical power import anomaly is identified on the premises of a subscriber 5-i, electrical power consumption units of the subscriber and/or further subscribers 5-i are driven in order to stabilize the electrical power import.

The inventive method is preferably performed in real time by a corresponding control program. In a possible embodiment, this control program can be stored in a program store. In a possible embodiment, identified or potential unauthorized interventions are logged and stored in a log store.

In a possible embodiment of the inventive method or the inventive apparatus, conspicuous control messages or control data packets that have been identified are blocked or reformatted in order that they can no longer cause destabilization of the electrical power distribution network. In a possible embodiment, the electrical power import anomaly identification unit identifies an electrical power import anomaly on the basis of conspicuous administrative data of the control messages or control data packets. In an alternative embodiment, the electrical power import anomaly identification unit identifies an electrical power import anomaly on the basis of conspicuous payload data of the transmitted control messages or control data packets. Reformatting of a conspicuous control message can consist in reformatting or recalculating oscillating data values within the payload data of the control message to produce a mean value, for example. If the price information oscillates between a price P0 and P1 in order to provoke a continuous switching on or off of electrical power consumption units 10, 11, the payload data of the corresponding control messages can be overwritten by a mean value or by a predefined value which indicates that the corresponding control message is to be ignored.

If the electrical power import anomaly identification unit identifies an unauthorized intervention that is intended to destabilize the electrical power distribution network 2 on the basis of the control message, it can report a type and a location of the respective unauthorized intervention to the server 4 of the infrastructure operator of the electrical power distribution network 2. Furthermore, the conspicuous control messages can be forwarded to the server 4 of the infrastructure operator for detailed analysis.

1-15. (canceled)

16. An apparatus for stabilizing an electrical power import by at least one subscriber from an electrical power distribution network, wherein the subscriber is connected to the electrical power distribution network via an electrical connection interface, the apparatus comprising:
means for identifying an electrical power import anomaly during the import of the electrical power by the respective subscriber from the electrical power distribution network based on transmitted control messages that are destined for the respective subscriber or originate from the respective subscriber; and
for driving electrical power consumption units or electrical power generation units accordingly after an electrical power import anomaly has been identified.

17. The apparatus according to claim 16, wherein a plurality of electrical power consumption units of the respective subscriber are connected via a gateway and the electrical connection interface of the subscriber to a distribution station, which is provided for the subscriber, of the electrical power distribution network.

18. The apparatus according to claim 17, wherein the electrical power import anomaly of a subscriber is identified by an electrical power import anomaly identification unit which is provided at the gateway of the respective subscriber, in the distribution station that is provided for the respective subscriber, or in a server of an electrical power supplier.

19. The apparatus according to claim 16, wherein after identification of an electrical power import anomaly on the premises of a subscriber, at least some of the electrical power consumption units of the subscriber and/or further subscribers are switched from a normal operating mode to a restricted operating mode or are deactivated completely.

20. The apparatus according to claim 16, which comprises an electrical power consumption calculation unit provided for the subscriber, for calculating, either continuously or as required, the electrical power that is consumed by the electrical power consumption units of the respective subscriber and an electrical power import anomaly identification unit of the respective subscriber connected to receive a report of the calculation by the electrical power consumption calculation unit.

21. The apparatus according to claim 17, which comprises an electrical power import anomaly identification unit configured to identify an electrical power import anomaly based on control messages that are sent from the gateway of the subscriber or received by the gateway of the subscriber.

22. The apparatus according to claim 16, wherein the control messages are transmitted via the electrical connection interface of the subscriber or via a separate data network.

23. The apparatus according to claim 16, which comprises an electrical power import anomaly identification unit of a subscriber configured to identify an electrical power import anomaly by comparing the transmitted control messages with predefined unauthorized-intervention patterns or with historically recorded data.

24. The apparatus according to claim 16, which comprises an electrical power import anomaly identification unit of a subscriber configured to identify an electrical power import anomaly whenever the transmitted control messages satisfy at least one configurable identification rule for identifying an electrical power import anomaly.

25. The apparatus according to claim 16, which comprises an electrical power import anomaly identification unit configured to perform one or more of the following additional checks for the purpose of identifying an electrical power import anomaly:
a check of the quantity of electrical power that the subscriber has imported from the electrical power distribution network or fed into the electrical power distribution network via the electrical connection interface;
a check of the integrity of the gateway of the subscriber; or
a check of switching instructions that are generated by the gateway of the subscriber, in respect of a chronological sequence and a frequency thereof.

26. The apparatus according to claim 17, wherein the gateway is configured to transmit the control messages by way of a predefined data transmission protocol and within a predefined data format.

27. The apparatus according to claim 26, wherein the control messages are data packets formed of administrative data and payload data, and wherein said electrical power import anomaly identification unit is configured to identify an electrical power import anomaly on a basis of conspicuous administrative data and/or conspicuous payload data of the transmitted control messages.

28. The apparatus according to claim 16, which comprises an electrical power import anomaly identification unit configured to identify an unauthorized intervention that is intended to destabilize the electrical power distribution network on the basis of the control messages, and to report a type and a location of the respective unauthorized intervention to a server of an infrastructure operator of the electrical power distribution network.

29. The apparatus according to claim 17, wherein a local electrical power import anomaly identification unit provided at the gateway of a subscriber is configured to load predefined unauthorized-intervention patterns for identifying electrical power import anomalies from a database or to receive the predefined unauthorized-intervention patterns in a training mode.

30. A method for stabilizing an electrical power import from an electrical power distribution network, the method which comprises:
identifying an electrical power import anomaly during the import of electrical power by at least one subscriber from the electrical power distribution network by analyzing transmitted control messages that are destined for the respective subscriber or originate from the respective subscriber;
upon identifying an electrical power import anomaly on the premises of a subscriber, driving electrical power consumption units of the subscriber and/or further subscribers to cause a stabilization of the electrical power import.
